(19) United States
(12) Patent Application Publication
(10) Pub. No.: US 2020/0167883 A1
(43) Pub. Date: May 28, 2020

(54) VEHICLE ALLOCATION MANAGEMENT DEVICE, VEHICLE ALLOCATION MANAGEMENT METHOD, AND COMPUTER PROGRAM FOR VEHICLE ALLOCATION MANAGEMENT

(71) Applicant: TOYOTA JIDOSHA KABUSHIKI KAISHA, Toyota-shi (JP)

(72) Inventors: Keiji YAMASHITA, Nisshin-shi (JP); Koichi Ikemoto, Nagoya-shi (JP); Koji Taguchi, Sagamihara-shi (JP); Shin Sakurada, Toyota-shi (JP); Tomoyuki Kuriyama, Hadano-shi (JP)

(73) Assignee: TOYOTA JIDOSHA KABUSHIKI KAISHA, Toyota-shi (JP)

(21) Appl. No.: 16/664,161

(22) Filed: Oct. 25, 2019

(30) Foreign Application Priority Data
Nov. 26, 2018 (JP) 2018-220593

(51) Int. Cl. G06Q 50/30; G08G 1/00; G06Q 10/04; G06Q 10/06

(52) U.S. Cl. CPC G06Q 50/30; G08G 1/202; G05D 1/0287; G06Q 10/06315; G06Q 10/047

(57) ABSTRACT

A vehicle allocation management device includes a number-of-insufficient-vehicles calculation unit configured to, for each of a plurality of districts, calculate a difference between the number of demanded vehicles of the district and the number of vehicles, which are already allocated in the district in a predetermined time period and are able to provide the mobility service, a movement destination decision unit configured to, for each of at least one movement target vehicle among the vehicles, decide a standby location of any one of candidate districts having the number of insufficient vehicles greater than zero among the districts as a movement destination of the movement target vehicle according to a position of the movement target vehicle after mobility service provision, and a vehicle allocation instruction unit configured to notify each movement target vehicle of the movement destination of the vehicle through a communication unit.

### INCORPORATION BY REFERENCE

The disclosure of Japanese Patent Application No. 2018-220593 filed on Nov. 26, 2018 including the specification, drawings and abstract is incorporated herein by reference in its entirety.

### BACKGROUND

### 1. Technical Field

The present disclosure relates to a vehicle allocation management device, a vehicle allocation management method, and a computer program for vehicle allocation management that allocate a vehicle for use in a mobility service.

### 2. Description of Related Art

A technique that uses a vehicle subjected to autonomous driving control as a vehicle for use in a mobility service, such as a taxi service or a ride-sharing service, has been suggested (for example, see Japanese Unexamined Patent Application Publication No. 2017-182137 (JP 2017-182137 A)).

For example, in a demand type operation system disclosed in JP 2017-182137 A, an operation management center creates, based on a use request from a user terminal and a reference operation schedule, in which an operation section, a departure place departure time, and a final destination arrival time are preset, an operation plan within an allowable range of the reference operation schedule, and provides the generated operation plan to a demand vehicle and the user terminal. The demand vehicle operates according to the created operation plan.

### SUMMARY

In the above-described technique, a position of a vehicle for use in a mobility service before the vehicle starts the service is not taken into consideration. For this reason, in some cases, even though a user who desires to use the mobility service requests vehicle allocation, a lot of time may be needed until the vehicle is actually allocated.

Accordingly, the disclosure provides a vehicle allocation management device capable of reducing a waiting time until a vehicle is actually allocated after a user requests vehicle allocation.

A first aspect of the disclosure relates to a vehicle allocation management device. The vehicle allocation management device includes a communication unit, a storage unit, a number-of-insufficient-vehicles calculation unit, a movement destination decision unit, and a vehicle allocation instruction unit. The communication unit is configured to perform communication with a plurality of vehicles, which is able to provide a mobility service, through a communication network. The storage unit is configured to, for each of a plurality of districts included in an area where the mobility service is provided, store a standby location in the district where a vehicle is able to be on standby. The number-of-insufficient-vehicles calculation unit is configured to, for each of the districts, calculate a difference between the number of demanded vehicles providing the mobility service in the district in a predetermined time period and the number of vehicles already allocated in the district in the predetermined time period among the vehicles as the number of insufficient vehicles. The movement destination decision unit is configured to, for each of at least one movement target vehicle among the vehicles, decide the standby location of any one of candidate districts having the number of insufficient vehicles greater than zero among the districts as a movement destination of the movement target vehicle according to a position of the movement target vehicle after mobility service provision. The vehicle allocation instruction unit is configured to notify each of the at least one movement target vehicle of the movement destination of the movement target vehicle through the communication unit.

In the vehicle allocation management device according to the first aspect of the disclosure, the movement destination decision unit may be configured to, for each of the at least one movement target vehicle, decide the standby location of any one of the candidate districts as the movement destination of the movement target vehicle such that, for each of the at least one movement target vehicle, a total of a movement distance or a needed time from the position of the movement target vehicle after the mobility service provision to the standby location of any one of the candidate districts becomes minimum.

The vehicle allocation management device according to the first aspect of the disclosure may further include a vehicle selection unit configured to select a vehicle, which is not boarded by a user, the movement destination of which is not decided, and a current position of which is different from the standby location of any one of the districts, from among the vehicles as the movement target vehicle. The movement destination decision unit may be configured to decide the movement destination with the current position of the movement target vehicle as the position after the mobility service provision.

In the vehicle allocation management device according to the first aspect of the disclosure, the vehicle selection unit may be configured to further select a vehicle, which is boarded by a user and a current position of which is within a predetermined range from a scheduled unboarding position of the user among the vehicles as the movement target vehicle. The movement destination decision unit may be configured to decide the movement destination with the scheduled unboarding position of the movement target vehicle being boarded by the user and having a current position within a predetermined range from the scheduled unboarding position of the user as the position after the mobility service provision.

In the vehicle allocation management device according to the first aspect of the disclosure, the movement destination decision unit may be configured to select the same number of districts as the at least one movement target vehicle in a descending order of the number of insufficient vehicles among the districts as the candidate districts.

In the vehicle allocation management device according to the first aspect of the disclosure, the movement destination decision unit may be configured to select the same number of districts as the at least one movement target vehicle in a descending order of the number of insufficient vehicles among the districts as the candidate districts.

The vehicle allocation management device according to the first aspect of the disclosure may further include a number-of-demanded-vehicles prediction unit configured to, for each of the districts, predict the number of demanded vehicles of the district according to the number of times in which, on a predetermined date in the past, a time at which the user boards any one of the vehicles is included in the predetermined time period and a position where the user boards the vehicle is included in the district.

A second aspect of the disclosure relates to a vehicle allocation management method. The vehicle allocation management method includes for each of a plurality of districts included in an area where a mobility service is provided, calculating a difference between the number of demanded vehicles providing the mobility service in the district in a predetermined time period and the number of vehicles already allocated in the district in the predetermined time period among a plurality of vehicles, which is able to provide the mobility service, as the number of insufficient vehicles, for each of at least one movement target vehicle among the vehicles, deciding a standby location, in which a vehicle is able to be on standby, of any one of candidate districts having the number of insufficient vehicles greater than zero among the districts as a movement destination of the movement target vehicle according to a position of the movement target vehicle after mobility service provision, and notifying each of the at least one movement target vehicle of the movement destination of the movement target vehicle through a communication unit, which is able to perform communication with the vehicles through a communication network.

A third aspect of the disclosure relates to a computer program for vehicle allocation management. The computer program causes a computer to execute for each of a plurality of districts included in an area where a mobility service is provided, calculating a difference between the number of demanded vehicles providing the mobility service in the district in a predetermined time period and the number of vehicles already allocated in the district in the predetermined time period among a plurality of vehicles, which is able to provide the mobility service, as the number of insufficient vehicles, for each of at least one movement target vehicle among the vehicles, deciding a standby location, in which a vehicle is able to be on standby, of any one of candidate districts having the number of insufficient vehicles greater than zero among the districts as a movement destination of the movement target vehicle according to a position of the movement target vehicle after mobility service provision, and notifying each of the at least one movement target vehicle of the movement destination of the movement target vehicle through a communication unit, which is able to perform communication with the vehicles through a communication network.

With the vehicle allocation management device according to the aspects of the disclosure, it is possible to reduce a waiting time until a vehicle is actually allocated after a user requests vehicle allocation.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic configuration diagram of a vehicle allocation management system in which a vehicle allocation management device according to an embodiment is mounted;

FIG. 2 is a schematic configuration diagram of a server as an example of the vehicle allocation management device;

FIG. 3 is a functional block diagram of a processor of the server related to vehicle allocation management processing;

FIG. 4 is a diagram showing an example of movement destination decision in a case where the number of movement target vehicles is one;

FIG. 5 is a diagram showing another example of movement destination decision in a case where the number of movement target vehicles is plural; and

FIG. 6 is an operation flowchart of the vehicle allocation management processing.

### DETAILED DESCRIPTION OF EMBODIMENTS

Hereinafter, a vehicle allocation management device and a vehicle allocation management system including the vehicle allocation management device will be described referring to the drawings. For each of a plurality of districts included in an area where a mobility service is provided, the vehicle allocation management device predicts the number of demanded vehicles for a vehicle able to provide the mobility service (hereinafter, simply referred to as a vehicle) in the district based on a use history of the mobility service in the past. Then, the vehicle allocation management device decides a standby location of each vehicle from among standby locations of districts where the number of insufficient vehicles to the predicted number of demanded vehicles is greater than zero such that a total of a movement distance or an estimated needed time from a current position of each vehicle, which does not carry a user at the current time and the standby position of which is not designated, to the standby location is minimized. With this, for each district, the vehicle allocation management device directs vehicles corresponding to the number of demanded vehicles of the district toward the standby locations of the districts in advance, thereby achieving a reduction in waiting time until the vehicle is actually allocated after the user requests vehicle allocation.

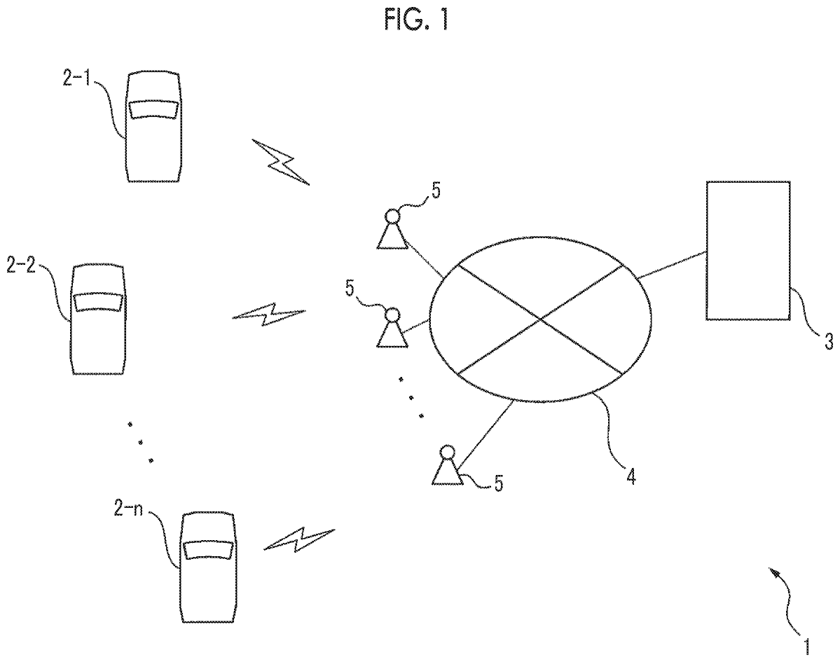

FIG. 1 is a schematic configuration diagram of a vehicle allocation management system in which a vehicle allocation management device according to an embodiment is mounted. A vehicle allocation management system 1 has a plurality of vehicles 2-1 to 2-n (where n is an integer equal to or greater than 2) that is able to provide a mobility service, and a server 3 that is an example of the vehicle allocation management device. Each of the vehicles 2-1 to 2-n receives a vehicle allocation instruction or a pickup instruction including information, such as a movement destination, from the server 3 through a communication network 4 constituted of an optical communication line and the like and a wireless base station 5 connected to the communication network 4 through a gateway (not shown), and moves to the movement destination. The server 3 is connected to the communication network 4, for example, through a gateway (not shown). Then, the server 3 transmits the vehicle allocation instruction or the pickup instruction representing the movement destination of the vehicle, or the like decided based on the number of demanded vehicles of each district to each of the vehicles 2-1 to 2-n through the communication network 4 and the wireless base station 5, thereby moving each vehicle to the movement destination of the vehicle. In the embodiment, the vehicle allocation instruction is an instruction to direct the vehicle toward the standby location of any one of a plurality of districts, and the pickup instruction is an instruction to direct the vehicle toward a scheduled boarding position designated by a user who desires to use a mobility service.

The vehicle allocation management system 1 may further have one or more portable terminals (not shown) that are able to perform communication with the server 3 through the wireless base stations 5 and the communication network 4. Such a portable terminal can be, for example, a mobile phone that is carried with the user who uses the mobility service. Then, the portable terminal transmits a vehicle allocation request including identification information of the user, a scheduled boarding position and a scheduled unboarding position (that is, a destination) of the user, and the like to the server 3 through the wireless base station 5 and the communication network 4 according to an operation of the user.

Each of the vehicles 2-1 to 2-n can be a vehicle subjected to autonomous driving control. To this end, each of the vehicles 2-1 to 2-n has, for example, a wireless terminal (not shown) that has a wireless communication function and is able to perform communication with the wireless base station 5, an electronic control unit (ECU) (not shown) that performs the autonomous driving control of the vehicle and controls respective units of the vehicle, and a positioning device that measures a position of the host vehicle. The positioning device may have, for example, a receiver that receives global positioning system (GPS) signals, and an arithmetic circuit that calculates the position of the vehicle from the GPS signals. Each of the vehicles 2-1 to 2-n may also have a storage device that stores map information, and a navigation system that obtains a traveling route from a current position of the vehicle to a movement destination. Each of the vehicles 2-1 to 2-n may also have an outside-vehicle sensor that obtains information surrounding the vehicle. The outside-vehicle sensor can be, for example, a camera that is provided to image the surroundings of the vehicle or a radar or a LIDER sensor that detects a distance to an object surrounding the vehicle. The wireless terminal, the positioning device, the storage device, the navigation system, and the outside-vehicle sensor are connected to perform communication with the ECU through an in-vehicle network (not shown) provided inside the vehicle conforming to a standard, such as a controller area network (CAN).

In each of the vehicles 2-1 to 2-n, in a case where the movement destination is notified from the server 3, the ECU notifies the navigation system of the movement destination through the wireless terminal. Then, the navigation system obtains the traveling route from the current position of the vehicle measured by the positioning device to the movement destination with reference to the map information. Similarly, for example, in a case where the user boards the vehicle at the notified scheduled boarding position, the navigation system obtains a traveling route from the scheduled boarding position or the current position of the vehicle to the scheduled unboarding position of the user with reference to the map information. Then, the navigation system notifies the ECU of the obtained traveling route. The ECU performs the autonomous driving control of the vehicle such that the vehicle moves to the movement destination or the scheduled unboarding position along the traveling route. In this case, the ECU may control the speed or the like of the vehicle using information surrounding the vehicle obtained by the outside-vehicle sensor such that an interval from another object surrounding the vehicle is maintained at a given interval or more. In a case where the traveling route is notified from the server 3, the ECU may perform the autonomous driving control of the vehicle such that the vehicle moves to the movement destination or the scheduled unboarding position along the notified traveling route. Then, in a case where the vehicle reaches the movement destination, the ECU transmits the effect that the vehicle reaches the movement destination, to the server 3 through the wireless terminal along with identification information of the vehicle. The ECU transmits the current position of the vehicle measured by the positioning device to the server 3 through the wireless terminal along with the identification information of the vehicle in every predetermined cycle (for example, 30 minutes, one minute, or five minutes). In a case where detection is made that the user boards the vehicle at the scheduled boarding position notified from the server 3, the ECU transmits a signal representing the user boards the vehicle (that is, the provision of the mobility service starts), the position of the vehicle at the time of boarding of the user measured by the positioning device, and a time of boarding obtained from an in-vehicle timepiece (not shown) to the server 3 through the wireless terminal along with the identification information of the vehicle. Similarly, in a case where detection is made that the user on board unboards the vehicle, the ECU transmits a signal representing the user unboards the vehicle (that is, the provision of the mobility service ends), the position of the vehicle at the time of unboarding of the user measured by the positioning device, and a time of unboarding obtained from the in-vehicle timepiece to the server 3 through the wireless terminal along with the identification information of the vehicle. For example, in a case where a door opening and closing sensor (not shown) detects that a door of the vehicle is opened at the scheduled boarding position, the ECU determines that the user boards the vehicle. Similarly, for example, in a case where the door opening and closing sensor detects that the door of the vehicle is opened at the scheduled unboarding position of the user on board, the ECU determines that the user unboards the vehicle. Alternatively, for each of the vehicles 2-1 to 2-n, a seating sensor may be provided in a seat of the vehicle. In this case, in a case where the seating sensor detects that the user sits on any seat, the ECU may determine that the user boards the vehicle. Similarly, in a case where the seating sensor does not detect the user who sits on any seat, the ECU may determine that the user unboards the vehicle. The seating sensor can be, for example, a pressure sensor that is provided in a seating surface of the seat or an optical sensor in which a light source, such as an infrared LED, and a detector receiving light emitted from the light source are arranged to face each other across the user who sits on the seat.

The server 3 is connected to the communication network 4, for example, through the gateway (not shown). For each of a plurality of districts, the server 3 predicts the number of demanded vehicles in the district in each time period based on a use history of the mobility service in the past. Then, the server 3 decides the standby location of each vehicle from among the standby locations of the districts having the number of insufficient vehicles to the predicted number of demanded vehicles greater than zero as the movement destination such that the total of the movement distance or the estimated needed time of each vehicle, which does not carry the user at the current time and the standby location of which is not decided, between the vehicles 2-1 and 2-2 from the current position to the standby location is minimized. Then, the server 3 notifies each vehicle of the movement destination of the vehicle through the communication network 4 and the wireless base station 5, and directs the vehicle toward the movement destination. The server 3 transmits a pickup instruction including the identification information of the user and the scheduled boarding position and the scheduled unboarding position of the user to any vehicle among the vehicles 2-1 to 2-n, for example, a vehicle closest to the scheduled boarding position indicated in the vehicle allocation request among the vehicles on standby at a standby location in any district through the communication network 4 and the wireless base station 5, and directs the vehicle toward the scheduled boarding position.

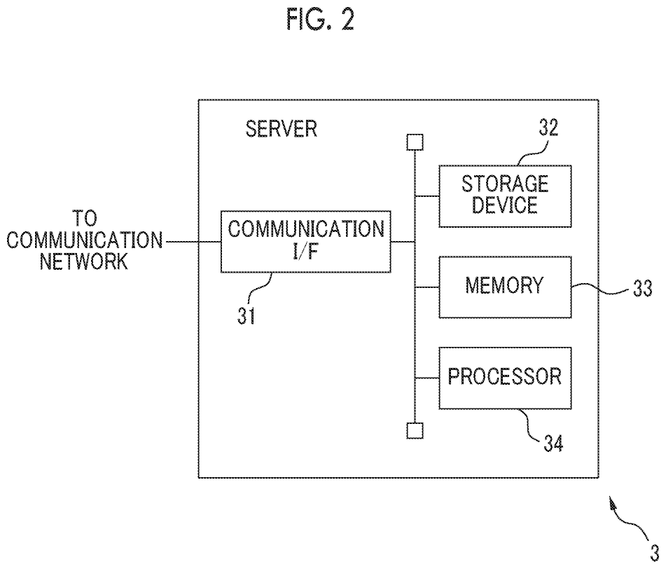

FIG. 2 is a schematic configuration diagram of the server 3 as an example of the vehicle allocation management device. The server 3 has a communication interface 31, a storage device 32, a memory 33, and a processor 34. The communication interface 31, the storage device 32, and the memory 33 are connected to the processor 34 through signal lines. The server 3 may also have an input device, such as a keyboard and a mouse, and an output device, such as a display.

The communication interface 31 is an example of a communication unit, and has an interface circuit that connects the server 3 to the communication network 4. The communication interface 31 is configured to perform communication with the wireless terminal of each of the vehicles 2-1 to 2-n through the communication network 4 and the wireless base station 5. That is, the communication interface 31 delivers a signal representing the current position of the vehicle, and the like received from the wireless terminal of any one of the vehicles 2-1 to 2-n through the wireless base station 5 and the communication network 4 to the processor 34. The communication interface 31 transmits the vehicle allocation instruction, the pickup instruction, or the like to any one of the vehicles 2-1 to 2-n received from the processor 34 to the vehicle through the communication network 4 and the wireless base station 5.

The storage device 32 is an example of a storage unit, and has, for example, a hard disk device or an optical recording medium and an access device thereof. Then, the storage device 32 stores, for each of the vehicles 2-1 to 2-n, the identification information of the vehicle, the current position of the vehicle, a flag representing a service provision state of the vehicle (for example, a state in which the vehicle waits for an instruction at a standby location, a state in which the vehicle is moving to a standby location, a state in which the vehicle is on standby, a state in which the vehicle is moving to the scheduled boarding position of the user, and a state in which the user is on board), a time (hereinafter, referred to as a state transition time) at which the latest service provision state is brought. The storage device 32 also stores the map information. The map information includes information (for example, a boundary of each district) representing a plurality of districts, and the standby locations of the districts where the vehicles 2-1 to 2-n are able to be on standby. The districts may be decided, for example, according to an administrative district, such as city, ward, or town, or may be decided in advance to include one or more facilities where people gather, such as a station, an airport, or a hotel. The standby location can be, for example, a parking lot of a facility where people gather, such as a station, an airport, or a hotel, or a parking lot owned or contracted by a service provider that provides the mobility service. A plurality of standby locations may be included in one district. The storage device 32 also stores a service use history in which a location (hereinafter, simply referred to as a boarding location) where the user boards any one of the vehicles 2-1 to 2-n and a time (hereinafter, simply referred to as a boarding time) at which the user boards the vehicle are recorded. The storage device 32 also stores the number of demanded vehicles and the number of insufficient vehicles of the mobility service in each time period. The time period is set to, for example, every one hour, every three hours, or every six hours. The storage device 32 may also store a computer program that executes vehicle allocation management processing.

The memory 33 is another example of a storage unit, and has, for example, a nonvolatile semiconductor memory and a volatile semiconductor memory. The memory 33 stores various kinds of data generated in execution of the vehicle allocation management processing, and the like.

The processor 34 is an example of a controller, and has one or a plurality of central processing units (CPUs) and peripheral circuits thereof. The processor 34 may further have another arithmetic circuit, such as a logical arithmetic unit or a numerical arithmetic unit. The processor 34 executes the vehicle allocation management processing.

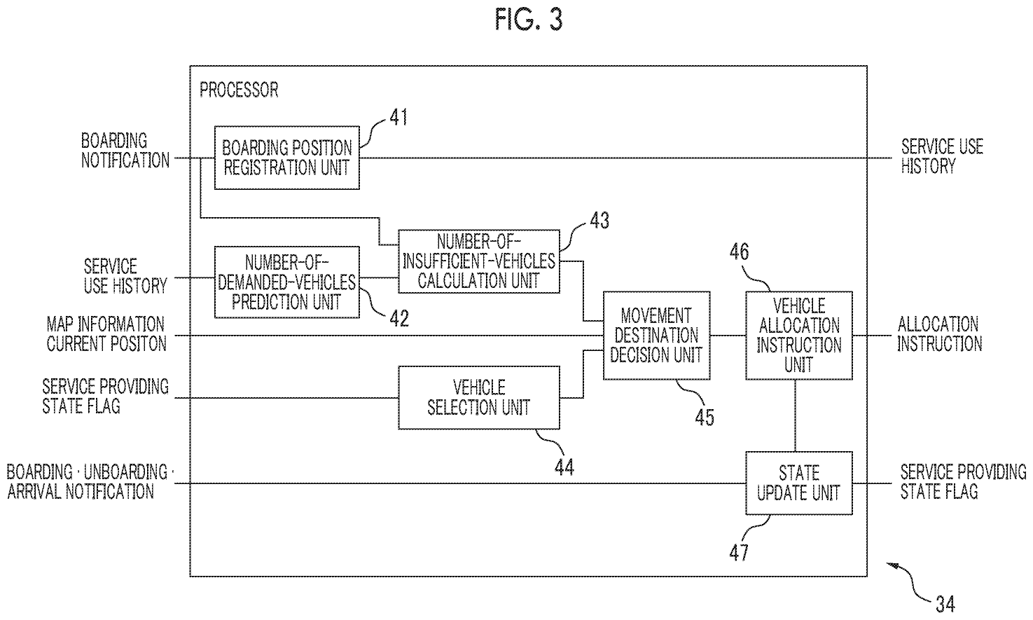

FIG. 3 is a functional block diagram of the processor 34 related to the vehicle allocation management processing. The processor 34 has a boarding position registration unit 41, a number-of-demanded-vehicles prediction unit 42, a number-of-insufficient-vehicles calculation unit 43, a vehicle selection unit 44, a movement destination decision unit 45, a vehicle allocation instruction unit 46, and a state update unit 47. The units in the processor 34 are, for example, functional modules that are implemented by a computer program running on the processor 34. Alternatively, the units in the processor 34 may be dedicated arithmetic circuits that are provided in the processor 34.

The boarding position registration unit 41 registers, for each of the vehicles 2-1 to 2-n, the boarding position and time of the user each time the user boards the vehicle. For example, each time the server 3 receives the boarding position and the boarding time from any one of the vehicles 2-1 to 2-n along with a signal representing that the user boards the vehicle, the boarding position registration unit 41 updates the service use history by recording a combination of the boarding position and the boarding time in the service use history. Then, the boarding position registration unit 41 records the update service use history in the storage device 32.

The number-of-demanded-vehicles prediction unit 42 predicts the number of demanded vehicles providing the mobility service of each time period for each of the districts in every predetermined cycle (for example, one day, one week, or one month). For example, for each of the districts, the number-of-demanded-vehicles prediction unit 42 counts the number of combination of a boarding position and a boarding time(hereinafter, referred to as the number of times of boarding), in which a time of boarding is included in a time period of interest (for example, 18 o'clock to 19 o'clock) and a boarding position is included in the district on any date in the past (for example, the day before, one week ago, one month ago, or one year ago), with reference to the service use history stored in the storage device 32, and predicts the number of times of boarding or the number of vehicles obtained by adding a predetermined offset to the number of times of boarding as the number of demanded vehicles in the time period of interest for the district. In this way, the number-of-demanded-vehicles prediction unit 42 predicts the number of demanded vehicles of each district based on the number of times in which the user boards the vehicle in each district in the time period of interest at a predetermined ratio in the past, thereby accurately predicting the number of demanded vehicles of each district.

In a case where the service use history is obtained over a plurality of days, for example, the number-of-demanded-vehicles prediction unit 42 may obtain the number of times of boarding in the same time period for each district and for each of the days. Then, for each district, the number-of-demanded-vehicles prediction unit 42 may set a statistical representative value, such as an average value, a mode value, a median value, of the number of times of boarding in the same time period in the district or the number of vehicles obtained by adding a predetermined offset to the statistical representative value as the number of demanded vehicles of the district in the time period.

Alternatively, for each district, the number-of-demanded-vehicles prediction unit 42 may predict the number of demanded vehicles for each of different environmental conditions in the district. Then, the number-of-demanded-vehicles prediction unit 42 may obtain the number of times of boarding in the same time period on each of the days, on which the service use history is obtained, for example, for each district and for the same environmental condition. Then, for each district, the number-of-demanded-vehicles prediction unit 42 may set a statistical representative value, such as an average value, a mode value, or a median value, of the number of times of boarding under the same environmental condition and in the same time period in the district or the number of vehicles obtained by adding a predetermined offset to the statistical representative value as the number of demanded vehicles under the environmental condition and in the time period in the district.

The environmental condition includes, for example, weather and an operation situation of a public transport. For example, in a case where weather is taken into consideration as the environmental condition, each time the boarding position and the boarding time are received from any one of the vehicles 2-1 and 2-2 along with the signal representing that the user boards the vehicle, the number-of-demanded-vehicles prediction unit 42 stores the weather of the boarding position in the storage device 32 in association with the boarding position and the boarding time. The weather of the boarding position may be acquired, for example, from another server, which is connected to perform communication with the server 3 through the communication network 4 and reports weather information, through the communication interface 31. Similarly, in a case where an operation situation of a public transport is taken into consideration as the environmental condition, and in a case where a facility (for example, a station or an airport)of a public transport usable by the user is present within a predetermined range (for example, 500 m to 3 km in all directions) from the boarding position, each time the boarding position and the boarding time are received from any one of the vehicles 2-1 and 2-2 along with the signal representing that the user boards the vehicle, the number-of-demanded-vehicles prediction unit 42 may store an operation situation of the public transport in the storage device 32 in association with the boarding position and the boarding time. The operation situation of the public transport may be acquired, for example, from another server, which is connected to perform communication with the server 3 through the communication network 4 and reports the operation situation of the public transport, through the communication interface 31.

The number-of-demanded-vehicles prediction unit 42 stores the predicted number of demanded vehicles of each district in each time period in the storage device 32 and notifies the number-of-insufficient-vehicles calculation unit 43 of the predicted number of demanded vehicles of each district in each time period.

For each of the districts, the number-of-insufficient-vehicles calculation unit 43 calculates the difference between the predicted number of demanded vehicles of the district in a time period including the current time, and the number of vehicles for providing the mobility service already allocated in the district in the time period as the number of insufficient vehicles. Then, for example, in a case where the time period of interest is started, for each district, the number-of-insufficient-vehicles calculation unit 43 set the predicted number of demanded vehicles in the time period of interest as the number of insufficient vehicles. For each district, in a case where the number of demanded vehicles is predicted for each of different environmental conditions, the number of demanded vehicles predicted for the same environmental condition as the environmental condition of the district at the current time may be used. Even in this case, the number-of-insufficient-vehicles calculation unit 43 may acquire the environmental condition at the current time in each district, for example, from another server, which is connected to perform communication with the server 3 through the communication network 4 and reports the environmental condition, through the communication interface 31. Then, for each district, in a case where any one of the vehicles 2-1 to 2-n is allocated in the district, the number-of-insufficient-vehicles calculation unit 43 decrements the number of insufficient vehicles of the district by one, thereby updating the number of insufficient vehicles of the district.

For example, the number-of-insufficient-vehicles calculation unit 43 can set a vehicle actually boarded by the user in any district among the vehicles 2-1 to 2-n as a vehicle for providing the mobility service allocated in the district. In this case, each time the boarding position and the boarding time are received from any one of the vehicles 2-1 to 2-n along with the signal representing that the user boards the vehicle, the number-of-insufficient-vehicles calculation unit 43 may decrement the number of insufficient vehicles in a district including the boarding position by one, thereby updating the number of insufficient vehicles.

Alternatively, the number-of-insufficient-vehicles calculation unit 43 can set a vehicle transmitting the pickup instruction among the vehicles 2-1 to 2-n as a vehicle for providing the mobility service allocated in a district including the scheduled boarding position of the user included in the pickup instruction. In this case, in a case where the server 3 transmits, to any one of the vehicles 2-1 to 2-n, the pickup instruction for directing the vehicle toward the scheduled boarding position of the user who transmits the vehicle allocation request, the number-of-insufficient-vehicles calculation unit 43 may decrement the number of insufficient vehicles of a district including the scheduled boarding position by one.

Alternatively, the number-of-insufficient-vehicles calculation unit 43 can set a vehicle transmitting the vehicle allocation instruction among the vehicles 2-1 to 2-n as a vehicle for providing the mobility service allocated in a district including the movement destination included in the vehicle allocation instruction. In this case, in a case where the server 3 transmits, to any one of the vehicles 2-1 to 2-n, the vehicle allocation instruction for directing the vehicle toward a standby location of any district, the number-of-insufficient-vehicles calculation unit 43 may decrement the number of insufficient vehicles of the district including the standby location by one.

For each of the districts, each time the number of insufficient vehicles of the district is updated, the number-of-insufficient-vehicles calculation unit 43 notifies the movement destination decision unit 45 of the number of insufficient vehicles after the update.

The vehicle selection unit 44 selects a vehicle, which does not carry the user at the current time, the standby location of which is not designated, and the current position of which is different from the standby location of any district (that is, not on standby), among the vehicles 2-1 to 2-n as a movement target vehicle to be moved to the standby location of any one of the districts, for example, in every predetermined cycle (for example, 30 seconds, one minute, or three minutes). With this, the vehicle selection unit 44 can appropriately select a vehicle, which is not providing the mobility service, among the vehicles 2-1 to 2-n as the movement target vehicle.

For example, the vehicle selection unit 44 may select a vehicle, for which the flag representing the service provision state stored in the storage device 32 is in a state of waiting for an instruction at a standby location, among the vehicles 2-1 to 2-n as the movement target vehicle.

Alternatively, each time the server 3 receives the signal representing unboarding of the user on board from any one of the vehicles 2-1 to 2-n through the wireless base station 5 and the communication network 4, the vehicle selection unit 44 may select the vehicle as the movement target vehicle.

According to another modification example, the vehicle selection unit 44 may select a vehicle, which is boarded by the user and the current position of which is within a predetermined range (for example, 500 m to 1 km) from the scheduled unboarding position of the user, among the vehicles 2-1 to 2-n as the movement target vehicle with reference to the current position of each vehicle, the scheduled unboarding position of the user on board, and the flag representing the service provision state stored in the storage device 32. With this, since the server 3 can transmit, even to a vehicle boarded by the user, the vehicle allocation instruction for directing the vehicle toward the standby location of any district before the user unboards the vehicle, it is possible to eliminate a time lag until the vehicle is notified of the movement destination after the user unboards the vehicle.

The vehicle selection unit 44 notifies the movement destination decision unit 45 of the identification information of the selected movement target vehicle.

Each time the movement target vehicle is selected, the movement destination decision unit 45 decides the standby location of any one of the districts as the movement destination for each of the selected movement target vehicles. In this case, the movement destination decision unit 45 selects districts having the number of insufficient vehicles greater than zero at the current time among the districts as candidate districts, the standby location of which can become the movement destination. Then, the movement destination decision unit 45 decides the standby location of any candidate district as the movement destination according to the position of the selected movement target vehicle after mobility service provision.

The movement destination decision unit 45 sets the current position of the movement target vehicle, which does not carry the user at the current time, the standby location of which is not designated, and the current position of which is different from the standby location of any district, as the position of the movement target vehicle after mobility service provision. Even in a case where a vehicle that transmits the signal representing that the user on board unboards the vehicle becomes the movement target vehicle, the movement destination decision unit 45 may set the current position of the movement target vehicle as the position of the movement target vehicle after the mobility service provision. Alternatively, in a case where a vehicle, which is boarded by the user, and the current position of which is within a predetermined range from the scheduled unboarding position of the user becomes the movement target vehicle, the movement destination decision unit 45 may set the scheduled unboarding position of the user on board as the position of the movement target vehicle after mobility service provision.

The movement destination decision unit 45 decides the movement destination of each selected movement target vehicle, for example, such that a total of a movement distance or an estimated needed time from the position after mobility service provision to the standby location to be the movement destination for each movement target vehicle is minimized. In this case, for each selected movement target vehicle, the movement destination decision unit 45 may obtain a traveling route from the position after mobility service provision to the standby location of each candidate district according to a predetermined route search method, such as a Dijkstra's algorithm, with reference to the map information, and may calculate the movement distance or the estimated needed time from the position after mobility service provision to the standby location of each candidate district according to the obtained traveling route. Alternatively, in order to reduce a computation amount, for each selected movement target vehicle, the movement destination decision unit 45 may calculate a distance from the position after mobility service provision to the standby location of each candidate district as a Euclidean distance from the current position and the standby location.

In a case where a plurality of selected movement target vehicles is present, the movement destination decision unit 45 may decide the movement destination of each selected movement target vehicle, for example, according to an optimization method, such as simulated annealing or a genetic algorithm, such that the total of the movement distance or the total of the estimated needed time is minimized. In this case, the movement destination decision unit 45 may set the standby location of the same candidate district as the movement destination of a plurality of movement target vehicles. Even in this case, it is preferable that the movement destination decision unit 45 decides the movement destination of each movement target vehicle such that the number of movement target vehicles having the standby location of the same candidate district as the movement destination does not exceed the number of insufficient vehicles of the candidate district.

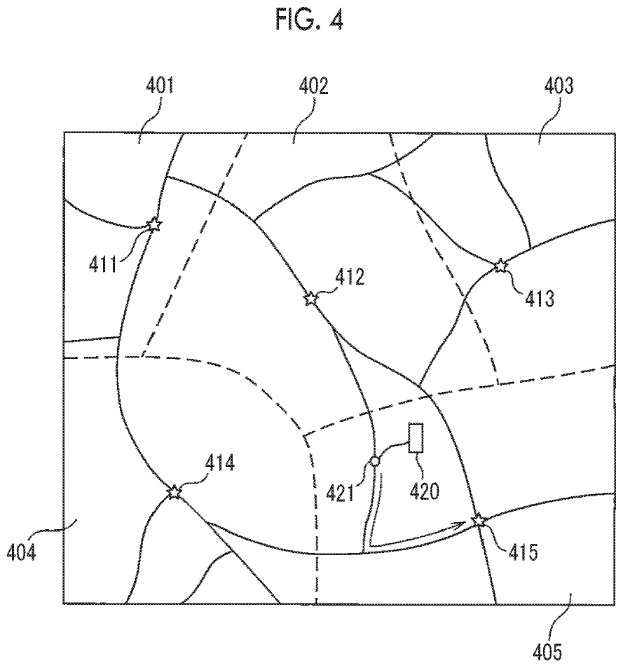

FIG. 4 is a diagram showing an example of movement destination decision in a case where the number of movement target vehicles is one. In the example, standby locations 411 to 415 are set in five districts 401 to 405, respectively. A movement target vehicle 420 is at a current position 421. It is assumed that, among the five districts 401 to 405, the districts 401, 403, 405 are candidate districts where the number of insufficient vehicles is greater than zero. In this case, among the standby locations of the respective candidate districts, the standby location 415 closest to the current position 421 of the movement target vehicle 420 is decided as a movement destination.

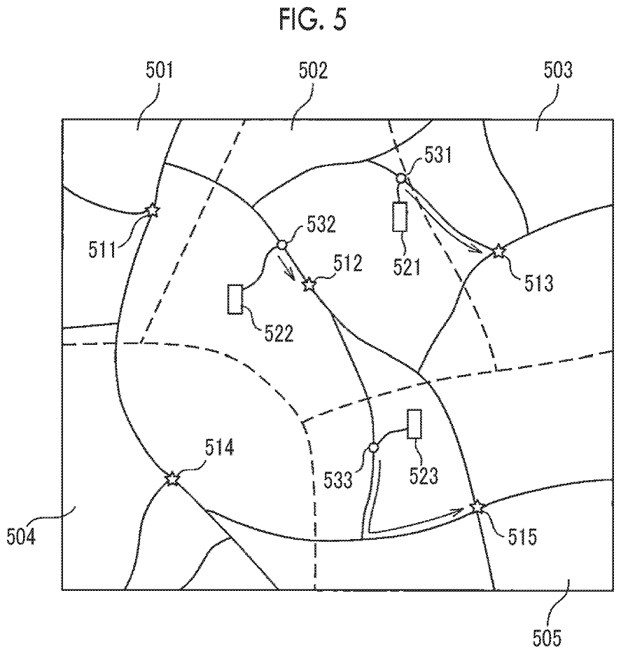

FIG. 5 is a diagram showing another example of movement destination decision in a case where the number of movement target vehicles is plural (in the example, three). In the example, standby locations 511 to 515 are set in five districts 501 to 505, respectively. Three movement target vehicles 521 to 523 are at current positions 531 to 533, respectively. In the example, it is assumed that all of the five districts 501 to 505 are candidate districts. In this case, among the standby locations 511 to 515 of the respective five candidate districts 501 to 505, the standby location 513 is decided as a movement destination of the movement target vehicle 521, the standby location 512 is decided as a movement destination of the movement target vehicle 522, and the standby location 515 is decided as a movement destination of the movement target vehicle 523 such that the total of the movement distance of the each of the movement target vehicles 521 to 523 is minimized.

The movement destination decision unit 45 notifies the vehicle allocation instruction unit 46 of the movement destination for each selected movement target vehicle.

The vehicle allocation instruction unit 46 creates a vehicle allocation instruction to move each selected movement target vehicle to the movement destination decided by the movement destination decision unit 45. Then, the vehicle allocation instruction unit 46 transmits the vehicle allocation instruction to each selected movement target vehicle through the communication interface 31, the communication network 4, and the wireless base station 5. In the vehicle allocation instruction, information (for example, a latitude and a longitude of the movement destination or a facility name of the movement destination) representing the movement destination, and identification information of the vehicle to be instructed are included. In the vehicle allocation instruction, information representing a current position of the vehicle to be instructed or a traveling route from a scheduled unboarding position to the movement destination for a user who unboards the vehicle last is also included.

Each time the server 3 receives the vehicle allocation request from the user, the vehicle allocation instruction unit 46 specifies any one of the vehicles on standby at the standby location closest to the scheduled boarding position included in the vehicle allocation request, for example, the vehicle on standby for the longest time at the standby location with reference to the current position of the vehicle, the service providing state flag, and the state transition time stored in the storage device 32. Then, the vehicle allocation instruction unit 46 creates a pickup instruction to move the specified vehicle to the scheduled boarding position included in the received vehicle allocation request and transmits the pickup instruction to the vehicle through the communication interface 31, the communication network 4, and the wireless base station 5. In this case, in the pickup instruction, for example, the identification information of the vehicle to be instructed, the identification information of the user who transmits the vehicle allocation request, and information representing the scheduled boarding position and the scheduled unboarding position are included. Information representing the scheduled boarding position includes, for example, a latitude and a longitude of the scheduled boarding position or a facility name at the scheduled boarding position. Similarly, information representing the scheduled unboarding position includes, for example, a latitude and a longitude of the scheduled unboarding position or a facility name at the scheduled unboarding position. In the pickup instruction, information representing a traveling route from the current position of the vehicle to the scheduled boarding position may also be included. In this case, the vehicle allocation instruction unit 46 may obtain the traveling route from the current position of the vehicle to the scheduled boarding position according to a predetermined route search method with reference to the map information.

Each time the vehicle allocation instruction or the pickup instruction is transmitted, the vehicle allocation instruction unit 46 notifies the state update unit 47 of the effect.

For each of the vehicles 2-1 to 2-n, each time the service provision state of the vehicle is changed, the state update unit 47 updates the flag representing the current service provision state. For example, in a case where the effect that the vehicle allocation instruction is transmitted is notified to any vehicle, the state update unit 47 rewrites the flag of the vehicle to a value representing that the vehicle is moving toward the standby location, and sets the state transition time to a time when the effect that the vehicle allocation instruction is transmitted is notified. In a case where the server 3 receives a signal representing arrival at the standby location from the vehicle that is moving toward the standby location, the state update unit 47 rewrites the flag of the vehicle to a value representing that the vehicle is on standby, and sets the state transition time to a time when the signal representing arrival at the standby location is received. In a case where the effect that the pickup instruction is transmitted is notified to any vehicle, the state update unit 47 rewrites the flag of the vehicle to a value representing that the vehicle is moving toward the scheduled boarding position of the user, and sets the state transition time to a time when the effect that the pickup instruction is transmitted is notified. In a case where the server 3 receives, from the vehicle moved to the scheduled boarding position of the user, the boarding time along with the signal representing that the user boards the vehicle, the state update unit 47 rewrites the flag of the vehicle to a value representing that the user is on board, and sets the state transition time to the received boarding time. In a case where the server 3 receives a time of unboarding of the user from the vehicle boarded by the user along with the signal representing that the user unboards the vehicle, the state update unit 47 rewrites the flag of the vehicle to a value representing a state of waiting for an instruction at a standby location, and sets the state transition time to the received time of unboarding of the user.

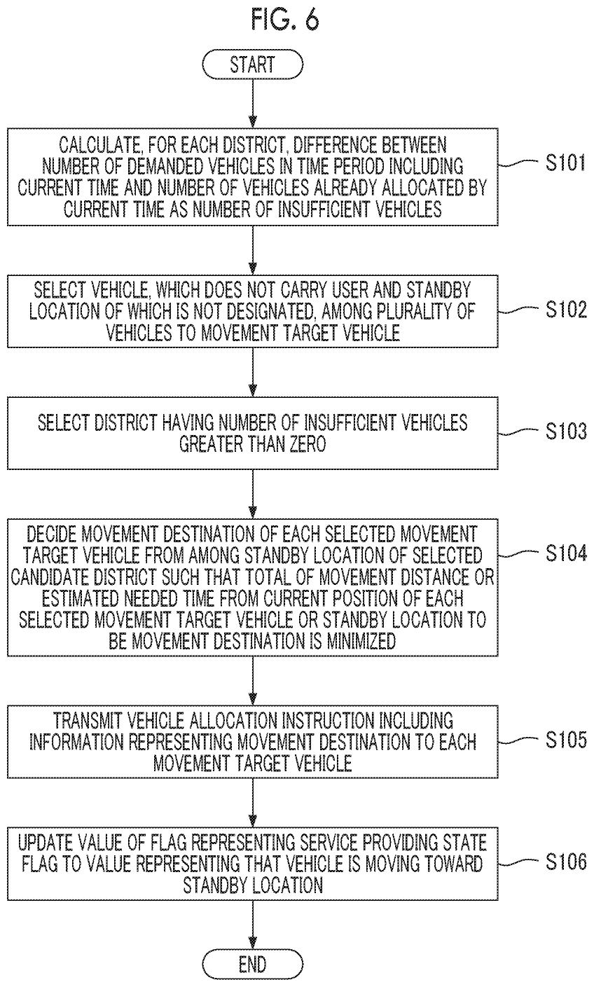

FIG. 6 is an operation flowchart of the vehicle allocation management processing. The processor 34 executes the vehicle allocation management processing according to the following operation flowchart, for example, in every predetermined cycle or each time the server 3 receives the signal representing unboarding of the user on board from any one of the vehicles 2-1 to 2-n.

The number-of-insufficient-vehicles calculation unit 43 of the processor 34 calculates, for each of the districts, the difference between the number of demanded vehicles predicted by the number-of-demanded-vehicles prediction unit 42 in the time period including the current time and the number of vehicles already allocated by the current time in the time period as the number of insufficient vehicles (Step S101).

The vehicle selection unit 44 of the processor 34 selects a vehicle, which does not carry the user at the current time and the standby location of which is not designated, among the vehicles 2-1 to 2-n to the movement target vehicle to be moved toward the standby location of any one of the districts (Step S102). Alternatively, as described above, the vehicle selection unit 44 may select even a vehicle, which is boarded by the user and the current position of which is within a predetermined range from the scheduled unboarding position of the user, as the movement target vehicle.

The movement destination decision unit 45 of the processor 34 selects the districts having the number of insufficient vehicles greater than zero among the districts as the candidate districts (Step S103). Then, the movement destination decision unit 45 decides the movement destination of each selected movement target vehicle from among the standby locations of the selected candidate districts such that the total of the movement distance or the estimated needed time from the current position of each selected movement target vehicle, that is, the position after mobility service provision to the standby location to be the movement destination is minimized (Step S104). In calculating the movement distance or the estimated needed time, for the movement target vehicle boarded by the user, the movement destination decision unit 45 may use, as the position after mobility service provision, the scheduled unboarding position of the user who unboards the vehicle last among the users who are boarding the vehicle, instead of the current position of the vehicle.

The vehicle allocation instruction unit 46 of the processor 34 creates the vehicle allocation instruction including information representing the movement destination for each selected movement target vehicle and transmits the created vehicle allocation instruction to each selected movement target vehicle through the communication interface 31 and the communication network 4 (Step S105). Then, for each selected movement target vehicle, the state update unit 47 of the processor 34 updates the value of the flag representing the service provision state to the value representing that the vehicle is moving toward the standby location (Step S106). Then, the processor 34 ends the vehicle allocation management processing.

As described above, the vehicle allocation management device decides the standby location of each vehicle from among the standby locations of the districts having the ratio of the number of insufficient vehicles to the predicted number of demanded vehicles greater than zero such that the total of the movement distance or the total of the estimated needed time from the position of each vehicle having no standby location decided from the position after the end of the mobility service to the standby location is minimized. Therefore, since the vehicle allocation management device can allocate the vehicles corresponding to the number of demanded vehicles for each district, it is possible to reduce a waiting time until the vehicle is actually allocated after the user requests vehicle allocation. The vehicle allocation management device decides the standby location for each vehicle having no standby location decided such that the total of the movement distance or the estimated needed time to the standby location is minimized, it is possible to reduce a movement distance when each vehicle is not boarded by the user or a needed time for movement to the standby location. As a result, the time from when the user who is boarding the vehicle unboards the vehicle until the vehicle can provide the mobility service for the next user is reduced, and the amount of energy consumption of the vehicle allocation management system as a whole is reduced.

According to the modification example, the movement destination decision unit 45 may select the same number of districts as the number of selected movement target vehicle in a descending order of the ratio (nd/nr) of the number of insufficient vehicles (nd) to the number of demanded vehicles (nr) among the districts having the number of insufficient vehicles greater than zero as the candidate districts. Alternatively, the movement destination decision unit 45 may select the same number of districts as the number of selected movement target vehicles in a descending order of the number of insufficient vehicles as the candidate districts. With this, the movement destination decision unit 45 can equalize the time until the number of vehicles to be allocated reaches the predicted number of demanded vehicles for each district.

In a case where the movement target vehicle is an electric vehicle or a plug-in hybrid vehicle that is driven by an electric motor with electricity as an energy source, and the remaining amount of energy of the movement target vehicle is equal to or less than a predetermined value, the movement destination decision unit 45 may select, as the candidate districts, districts where a standby location has a charging facility among the districts having the number of insufficient vehicles greater than zero. With this, while the vehicle is on standby at the standby location, the vehicle can be charged.

Any one of the vehicles 2-1 to 2-n may be a manned driving vehicle in which a driver drives the vehicle. In this case, the driver of the vehicle who receives a vehicle allocation instruction from the server 3 may drive the vehicle so as to direct the vehicle toward a standby location of a district indicated in the vehicle allocation instruction.

In addition, the number of demanded vehicles of each of a plurality of districts may be input by a manager of the server 3 through the input device of the server 3 or may be acquired from another equipment, which is connected to the server 3 through the communication network, through the communication interface 31 and may be stored in advance in the storage device 32. In this case, the number-of-demanded-vehicles prediction unit 42 may be omitted.

A computer program that causes a computer to execute the processing executed by the processor 34 of the server 3 may be distributed, for example, in a state of being recorded on a recording medium, such as an optical recording medium or a magnetic recording medium.

As described above, those skilled in the art can make various alterations to the embodiment without departing from the spirit and scope of the disclosure.

What is claimed is:

1. A vehicle allocation management device comprising:
a communication unit configured to perform communication with a plurality of vehicles, which is able to provide a mobility service, through a communication network;
a storage unit configured to, for each of a plurality of districts included in an area where the mobility service is provided, store a standby location in the district where a vehicle is able to be on standby;
a number-of-insufficient-vehicles calculation unit configured to, for each of the districts, calculate a difference between the number of demanded vehicles providing the mobility service in the district in a predetermined time period and the number of vehicles already allocated in the district in the predetermined time period among the vehicles as the number of insufficient vehicles;
a movement destination decision unit configured to, for each of at least one movement target vehicle among the vehicles, decide the standby location of any one of candidate districts having the number of insufficient vehicles greater than zero among the districts as a movement destination of the movement target vehicle according to a position of the movement target vehicle after mobility service provision; and
a vehicle allocation instruction unit configured to notify each of the at least one movement target vehicle of the movement destination of the movement target vehicle through the communication unit.

2. The vehicle allocation management device according to claim 1, wherein the movement destination decision unit is configured to, for each of the at least one movement target vehicle, decide the standby location of any one of the candidate districts as the movement destination of the movement target vehicle such that, for each of the at least one movement target vehicle, a total of a movement distance or a needed time from the position of the movement target vehicle after the mobility service provision to the standby location of any one of the candidate districts becomes minimum.

3. The vehicle allocation management device according to claim 1, further comprising a vehicle selection unit configured to select a vehicle, which is not boarded by a user, the movement destination of which is not decided, and a current position of which is different from the standby location of any one of the districts, from among the vehicles as the movement target vehicle,
wherein the movement destination decision unit is configured to decide the movement destination with the current position of the movement target vehicle as the position after the mobility service provision.

4. The vehicle allocation management device according to claim 3, wherein:
the vehicle selection unit is configured to further select a vehicle, which is boarded by a user and a current position of which is within a predetermined range from a scheduled unboarding position of the user among the vehicles as the movement target vehicle; and
the movement destination decision unit is configured to decide the movement destination with the scheduled unboarding position of the movement target vehicle being boarded by the user and having a current position within a predetermined range from the scheduled unboarding position of the user as the position after the mobility service provision.

5. The vehicle allocation management device according to claim 1, wherein the movement destination decision unit is configured to select the same number of districts as the at least one movement target vehicle in a descending order of a ratio of the number of insufficient vehicles to the number of demanded vehicles among the districts as the candidate districts.

6. The vehicle allocation management device according to claim 1, wherein the movement destination decision unit is configured to select the same number of districts as the at least one movement target vehicle in a descending order of the number of insufficient vehicles among the districts as the candidate districts.

7. The vehicle allocation management device according to claim 1, further comprising a number-of-demanded-vehicles prediction unit configured to, for each of the districts, predict the number of demanded vehicles of the district according to the number of times in which, on a predetermined date in the past, a time at which the user boards any one of the vehicles is included in the predetermined time period and a position where the user boards the vehicle is included in the district.

8. A vehicle allocation management method comprising:
for each of a plurality of districts included in an area where a mobility service is provided, calculating a difference between the number of demanded vehicles providing the mobility service in the district in a predetermined time period and the number of vehicles already allocated in the district in the predetermined time period among a plurality of vehicles, which is able to provide the mobility service, as the number of insufficient vehicles;
for each of at least one movement target vehicle among the vehicles, deciding a standby location, in which a vehicle is able to be on standby, of any one of candidate districts having the number of insufficient vehicles greater than zero among the districts as a movement destination of the movement target vehicle according to a position of the movement target vehicle after mobility service provision; and
notifying each of the at least one movement target vehicle of the movement destination of the movement target vehicle through a communication unit, which is able to perform communication with the vehicles through a communication network.

9. A computer program for vehicle allocation management causing a computer to execute
for each of a plurality of districts included in an area where a mobility service is provided, calculating a difference between the number of demanded vehicles providing the mobility service in the district in a predetermined time period and the number of vehicles already allocated in the district in the predetermined time period among a plurality of vehicles, which is able to provide the mobility service, as the number of insufficient vehicles,
for each of at least one movement target vehicle among the vehicles, deciding a standby location, in which a vehicle is able to be on standby, of any one of candidate districts having the number of insufficient vehicles greater than zero among the districts as a movement destination of the movement target vehicle according to a position of the movement target vehicle after mobility service provision, and
notifying each of the at least one movement target vehicle of the movement destination of the movement target vehicle through a communication unit, which is able to perform communication with the vehicles through a communication network.
